(19) United States
(12) Patent Application Publication
(10) Pub. No.: US 2006/0132557 A1
(43) Pub. Date: Jun. 22, 2006

(54) Liquid package, liquid droplet ejection device, electro-optic device, and electronic equipment

(75) Inventor: Kei Hiruma, Chino-shi (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/298,743

(22) Filed: Dec. 12, 2005

(30) Foreign Application Priority Data
Dec. 16, 2004 (JP) 2004-364538

(51) Int. Cl. B41J 2/175

(52) U.S. Cl. 347/85

(57) ABSTRACT

A liquid package includes a bag in which is sealed a liquid that is degasified at a pressure higher than a saturated vapor pressure of a solvent in the liquid.

### CROSS-REFERENCE TO RELATED APPLICATION

This application claims priority to Japanese Patent Application No. 2004-364538, filed Dec. 16, 2004, the contents of which are incorporated herein by reference.

### BACKGROUND

1. Technical Field

The present invention relates to a liquid package, liquid droplet ejection device, electro-optic device, and electronic equipment.

2. Related Art

In liquid crystal display devices, an alignment film having a function to align liquid crystal molecules is deposited and formed by flexography methods and spin-coating methods.

In recent years, the use of liquid droplet ejection methods (liquid droplet ejection devices) to form an alignment film by ejecting a liquid including alignment film formation material as liquid droplets from a ejection head has been studied, with the aims of reducing material consumption and providing improved quality.

In the related art, the liquid for supplying to the ejection head is degassed, in order to resolve a droplet ejection failure arising from cavitation and other problems and to prevent declines in production yields due to film fabrication defects. For example, Japanese Unexamined Patent Application, First Publication No. H11-42796 discloses technology in which a bundle of hollow members is positioned in the liquid supply channel between liquid tank and head to remove the air dissolved in the liquid.

However, in the case of the technology, there is the possibility that liquid stored within the liquid tank may come into contact with air within the tank, so that oxidation or some other degradation with time may occur.

Furthermore, the difference in the heights (the water head value) of the liquid interface within the tank and the nozzle face of the head easily fluctuates, and as the amount of ink remaining changes, there is the possibility that ejection may be come unstable. Furthermore, due to vaporization of the solvent portion accompanying degassing, there is the possibility that ink may become viscous and solidify within the hollow members (tubes).

### SUMMARY

An advantage of some aspects of the invention is to eliminate adverse effects of air contained in liquid.

A further object of some aspects of the invention is to suppress unstable ejection of droplets due to fluctuations in water head value.

A liquid package according to an aspect of the invention includes: a bag in which is sealed a liquid that is degasified at a pressure higher than the saturated vapor pressure of a solvent in the liquid.

In accordance with an embodiment of the invention, the liquid is degassed in advance, so that adverse effects due to degradation from oxidation or similar, volatility of the solvent portion or similar, and contact with air, can be excluded.

Furthermore, an increase in viscosity due to vaporization of solvent contained in the liquid during degassing can be prevented.

It is preferable that a configuration be adopted in which, when the liquid has plural solvents, the liquid is degassed and sealed under a pressure higher than a saturated vapor pressure of one of the solvents with a highest saturated vapor pressure, and a configuration in which the liquid is degassed and sealed under a pressure higher than a saturated vapor pressure of the solvents with the highest composition ratio.

When the liquid is degassed and sealed under a pressure higher than the saturated vapor pressure of the solvent with the highest saturated vapor pressure, vaporization can be prevented for all of the solvents. Moreover, when the liquid is degassed and sealed under a pressure higher than the saturated vapor pressure of the solvent with the highest composition ratio, adverse effects due to solvent vaporization, such as increases in viscosity, can be held to a minimum.

In this case, sealing of the liquid within a bag having flexibility contributes to ease of handling, and can also enhance ease of extraction of the liquid through the action of atmospheric pressure.

A liquid droplet ejection device according to an aspect of the invention includes: an ejection head which ejects droplets; and a supply unit which supplies a liquid to the ejection head and has the above liquid package.

In accordance with an embodiment of the invention, it is possible to suppress declines in production efficiency and worsening of production yields arising from characteristic fluctuations and ejection defects due to contact between the liquid and air.

It is preferable that the liquid package have a flat shape and a liquid supply port and is placed substantially horizontally, and the liquid supply port is directed in a substantially horizontal direction.

In this case, even if liquid removal (supply) from the liquid package occurs, because the water head value can be held substantially constant, unstable ejection due to fluctuations in the water head value can be prevented.

It is preferable that the liquid droplet ejection device include an elevating device which raises and lowers the liquid package.

In this case, the liquid package can be raised or lowered to set the liquid ejection surface at substantially the same height as the ejection head and maintain a constant water head value, so that liquid ejection can be maintained in a stable state.

An electro-optic device according to an aspect of the invention includes a substrate manufactured by using the above liquid droplet ejection device.

An electronic equipment according to an aspect of the invention has the above electro-optic device.

In accordance with an embodiment of the invention, declines in quality due to liquid ejection defects, and declines in production efficiency due to reduced production yields, can be prevented.

### BRIEF DESCRIPTION OF THE DRAWINGS

FIG. 1 is a summary perspective view of a liquid droplet ejection device.

FIG. 2 is a diagram to explain the principle of ejection of a liquid by a piezo-electric method.

FIG. 3 is a diagram showing the state of connection of an ink package and a droplet ejection head.

FIG. 4 is a flowchart showing a procedure for fabrication of an ink package.

FIG. 5 is an equivalent circuit diagram of a liquid crystal device.

FIG. 6 is a plan view showing the pixel structure of the liquid crystal device of FIG. 5.

FIG. 7 is a cross-sectional view showing the principal portions of the liquid crystal device of FIG. 5.

FIG. 8 is a diagram explaining processes, showing an example of a method of manufacture of the liquid crystal device of FIG. 5.

FIG. 9A is a perspective view showing one example of electronic equipment of this invention.

FIG. 9B is a perspective view showing one example of electronic equipment of this invention.

FIG. 9C is a perspective view showing one example of electronic equipment of this invention.

### DESCRIPTION OF EXEMPLARY EMBODIMENTS

Below, aspects of a liquid package (an ink package), liquid droplet ejection device, electro-optic device, and electronic equipment of the invention are explained, referring to the drawings.

Ink Package and Liquid Droplet Ejection Device

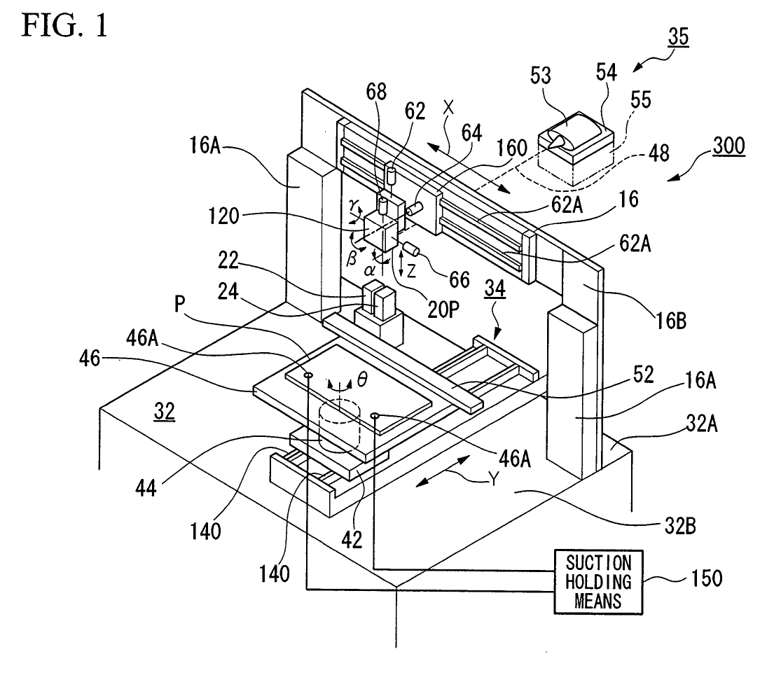

First, a liquid droplet ejection device in which an ink package is used is explained. FIG. 1 is a perspective view showing in summary the configuration of a liquid droplet ejection device 300.

The liquid droplet ejection device 300 has a base 32, first movement means 34, second movement means 16, droplet ejection head (ejection head) 120, capping unit 22, cleaning unit 24, and similar. The first movement means 34, capping unit 22, cleaning unit 24, and second movement means 16 are each positioned on the base 32.

It is preferable that the first movement means 34 be positioned directly on the base 32, and that the first movement means 34 be positioned along the Y-axis direction. The second movement means 16 is installed vertically with respect to the base 32 using the supports 16A, and the second movement means 16 is installed in the rear portion of the base 32. The X-axis direction of the second movement means 16 is orthogonal to the Y-axis direction of the first movement means 34. The Y axis is along the direction between the forward portion 32B and the rear portion 32A of the base 32. The X axis is the axis along the lateral direction of the base 32. Each of X and Y axes is horizontal.

The first movement means 34 has guide rails 140; the first movement means 34 can for example adopt a linear motor. The slider 42 of linear-motor type first movement means 34 moves along the guide rails 140, and is positioned at an arbitrary position in the Y axis direction. The table 46 holds the substrate P which is the workpiece, and positions the substrate P. The table 46 has suction holding means 150. By operating the suction holding means 150, the substrate P is suction-fastened and held onto the table 46 via holes 46A in the table 46. A preparatory ejection area 52 is provided on the table 46, for use in elimination ejection or test ejection (preparatory ejection) by the droplet ejection head 120.

The second movement means 16 has a column 16B fixed onto the supports 16A; on this column 16B is provided the second movement means 16 of linear-motor type. The slider 160 moves along the guide rail 62A, and is positioned at an arbitrary position in the X-axis direction. A droplet ejection head 120 is provided, as ink ejection means, on the slider 160.

The slider 42 also comprises a 0 axis motor 44. This motor 44 is for example a direct-drive motor, and the rotor of the motor 44 is fixed on the table 46. By passing current through the motor 44, the rotor and table 46 are caused to rotate in the θ direction, and the table 46 can be indexed (incrementally rotated).

The droplet ejection head 120 has motors 62, 64, 66, 68 as means of pivoting positioning. By operating the motor 62, the droplet ejection head 120 moves along the Z axis and is positioned. The Z axis is orthogonal to the X axis and Y axis (in the vertical direction). By operating the motor 64, the droplet ejection head 120 pivots and is positioned along the β direction about the Y axis. By operating the motor 66, the droplet ejection head 120 pivots and is positioned in the γ direction about the X axis. By operating the motor 68, the droplet ejection head 120 pivots and is positioned in the α direction about the Z axis.

In this way, the droplet ejection head 120 of FIG. 1 is moved linearly and positioned in the X-axis direction via the slider 160, and is pivoted and positioned along the α, β, γ directions, so that the position and attitude of the ink ejection surface 20P of the droplet ejection head 120 is controlled accurately with respect to the substrate P on the table 46. A plurality (for example, 120) of nozzles (ejection portions) each of which ejection ink are provided on the ink ejection surface 20P of the droplet ejection head 120. Liquid is supplied from the supply device (supply unit) to the droplet ejection head 120.

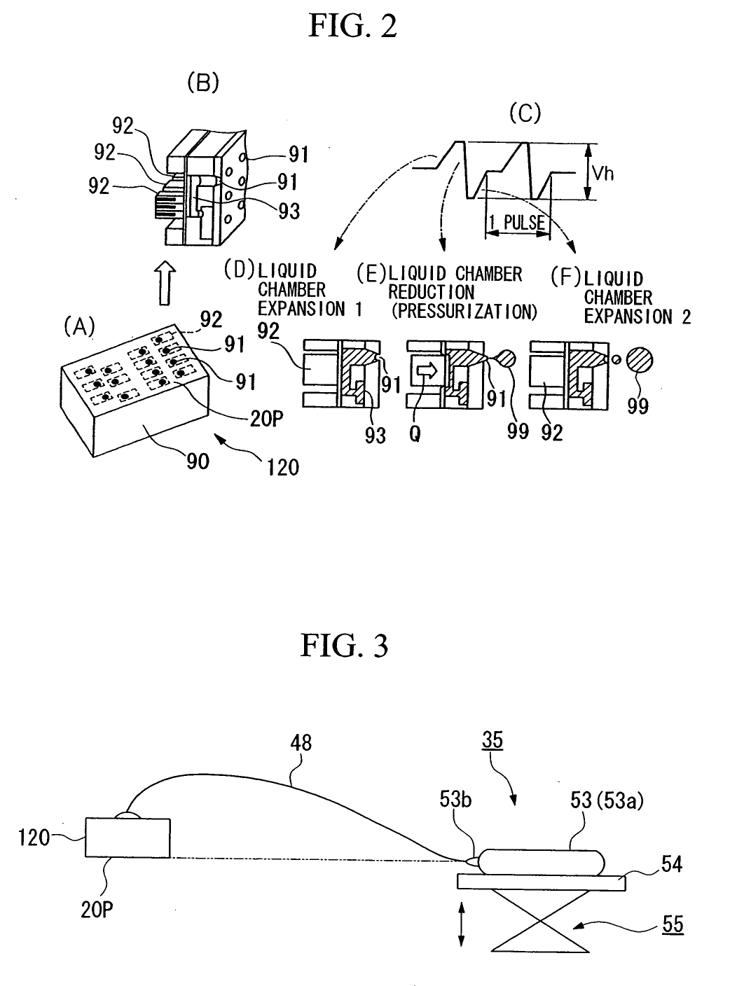

Here, an example of the configuration of a droplet ejection head 120 is explained, referring to FIG. 2. The droplet ejection head 120 is for example a head which uses a piezo element (piezo-electric element). As shown in part (A) of FIG. 2, a plurality of nozzles (ejection portions) 91 are formed in the ink ejection surface 20P of the head main unit 90. Piezo elements 92 are provided for each of these nozzles 91. As shown in part (B) of FIG. 2, the piezo elements 92 are arranged to correspond to nozzles 91 and an ink chamber (liquid chamber) 93. For example, a piezo element 92 may be positioned between a pair of electrodes (not shown), and configured so as to expand upon passage of a current. When an applied voltage Vh shown in part (C) of FIG. 2 is applied to a piezo element 92, the piezo element 92 expands and contracts in the direction of the arrow Q, as shown in parts (D), (F) and (E) of FIG. 2, the ink chamber 93 is pressurized, and a liquid droplet (ink droplet) 99 is ejected from the nozzle 91 in a prescribed amount. Driving of the piezo element 92, that is, droplet ejection from the droplet ejection head 120, is controlled by a control device (not shown).

Returning to FIG. 1, the supply device 35 has a ink package (liquid package) 53 which is sealed the liquid for supply to the droplet ejection head 120, a support portion 54 which detachably supports the ink package 53, an elevating device 55 which raises and lowers the support portion 54, and a supply tube 48 to send liquid from the ink package 53 to the droplet ejection head 120.

The ink package 53 has a flexible bag 53a with for example a polyethylene surface onto which aluminum has been evaporation-deposited, and into which a degassed liquid has been sealed in the decompressed state. Furthermore the ink package has a removal aperture (a liquid supply port) 53b formed from rubber or some other elastic material. The removal aperture 53b has an insertion aperture, not shown. By inserting into this insertion aperture a hollow tube, such as for example an injection needle, connected to the supply tube 48, liquid is guided into the supply tube 48. When the hollow tube is withdrawn from the insertion aperture, the insertion aperture is obstructed by means of the elastic force of the removal aperture 53b itself, so that liquid does not leak.

The bag 53a is for example formed into a short and broad (substantially flat) shape, which in plane view (seen from obliquely above in FIG. 1) is a rectangle the length and width of which is approximately 10 cm, and of thickness approximately 1 cm. As shown in FIG. 1 and FIG. 3, the bag 53a is placed substantially horizontally on the support portion 54, with the removal aperture 53b directed in a horizontal direction.

The elevating device 55 includes a jack, pneumatic cylinder, or other actuator, and raises and lowers (adjusts the height of) the ink package 53 via the support portion 54.

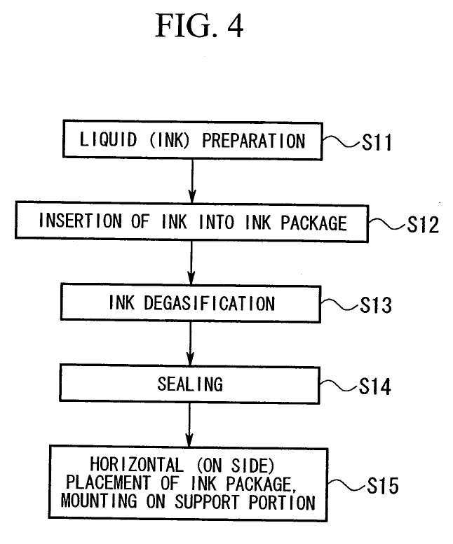

Next, a procedure for fabrication of an ink package 53 is explained, referring to the flowchart shown in FIG. 4.

First, a prescribed solute (for example a polyimide) is dissolved in a solvent to prepare a liquid of prescribed density (a solution; hereafter called “ink”)(step S11). Next, the ink thus prepared is injected into an ink package 53 (step S12), and is degassed in a depressurized state (in a reduced-pressure environment) (step S13). This depressurized state is at a pressure exceeding the saturated vapor pressure of the solvent, in order to prevent vaporization of the solvent contained in the ink.

When the ink includes a solvent mixture having a plurality of types of solvents, by performing degassing at a pressure exceeding the saturated vapor pressure of the solvent having the highest saturated vapor pressure among the plurality of types of solvents, vaporization of any of the solvents can be prevented.

Furthermore, when the ink includes a solvent mixture having a plurality of types of solvents, degassing can be performed at a pressure exceeding the saturated vapor pressure of the solvent with the largest composition ratio. In this case, by preventing vaporization of the solvent having the largest composition ratio, increases in viscosity and other adverse effects of solvent vaporization can be held to a minimum.

When degasification of the ink is completed, the ink package 53 is sealed (step S14), and is positioned horizontally (on its side) on the support portion 54 (step S15).

Next, a procedure of applying the ink (for example, alignment film solution) to the substrate P, using the droplet ejection device 300, is explained.

First, the support portion 54, on which the ink package 53 has been mounted in advance, is moved vertically to adjust the height of the ink package 53. Specifically, by driving the elevating device 55 the ink package 53 is raised or lowered through the support portion 54, and the removal aperture 54b of the ink package is set to substantially the same height as the ink ejection surface 20P of the droplet ejection head 120, as shown in FIG. 3.

The ink package 53 is short and broad (flat), and is placed horizontally on the support portion 54, so that even when the ink within the ink package 53 is consumed, there is substantially no change in the liquid surface within the ink package 53. Hence the water head value between the droplet ejection head 120 and the ink package 53 is kept substantially constant.

When adjustment of the height of the ink package 53 is completed, the slider 160 is driven to move the droplet ejection head 120 to a position opposing the capping unit 22. The capping unit 22 is placed into contact against the ink ejection surface 20P of the droplet ejection head 120, and by means of negative-pressure suction, ink within the ink package 53 is supplied to the droplet ejection head 120 via the supply tube 48, and fills the ink chamber 93.

Thereafter, relative positioning of the substrate P and droplet ejection head 120 is performed, and while scanning the substrate P in one direction relative to the droplet ejection head 120, ink is ejected from each of the nozzles 91. Due to the negative pressure within the head 120 (ink chamber 93) arising from this ink ejection, ink is supplied to the head 120 from the ink package 53. By drying the substrate P onto which ink ejected from the head 120 has been applied, a film is formed on the substrate P.

Thus in this aspect, the ink within the ink package 53 is degasified in advance in a reduced-pressure state, so that adverse effects on droplet ejection due to air contained in the ink, such as contact of the ink with air resulting in oxidation or other degradation with time, droplet ejection failures arising from cavitation, or other problems, can be eliminated. Furthermore, in this aspect the ink package 53 is formed as a bag 53a with flexibility, contributing to improved ink removal performance; and because atmospheric pressure acts on the ink within the ink package 53 through the bag 53a, the ink removal performance (supply performance) can be improved.

In addition, in this aspect the ink package 53 is formed in a sheet-like shape, and moreover is placed substantially horizontally, so that even if ink consumption advances within the ink package 53, the change in the ink liquid surface can be made small. Hence the water head value in the droplet ejection head 120 is held constant with almost no fluctuation, and stabilized ink ejection can be continued. Moreover, in this aspect the elevating device 55 can easily be set such that the ink package 53 and the ink ejection surface 20P of the droplet ejection head 120 are at substantially the same height, so that ink leaks, ejection defects and other problems arising from the water head value can be prevented.

Moreover, in this aspect the ink degasification is performed at a pressure exceeding the saturated vapor pressure of the solvent, so that vaporization of the solvent in the ink during degasification can be prevented. Also in this aspect, when the ink includes a solvent mixture having a plurality of types of solvents, degasification is performed at a pressure exceeding the saturated vapor pressure of the solvent, among the plurality of solvent types, with the highest saturated vapor pressure, so that vaporization of any of the solvents can be prevented; and, degasification is performed at a pressure exceeding the saturated vapor pressure of the solvent with the highest composition ratio among the plurality of solvent types, so that vaporization of the solvent with the highest composition ratio can be prevented, and adverse effects of solvent vaporization, such as increases in viscosity, can be held to a minimum.

Liquid Crystal Display Device

Next, a liquid crystal panel (device) manufactured using the above-described droplet application device, and a liquid crystal display device (electro-optic device) having such a liquid crystal panel, are described.

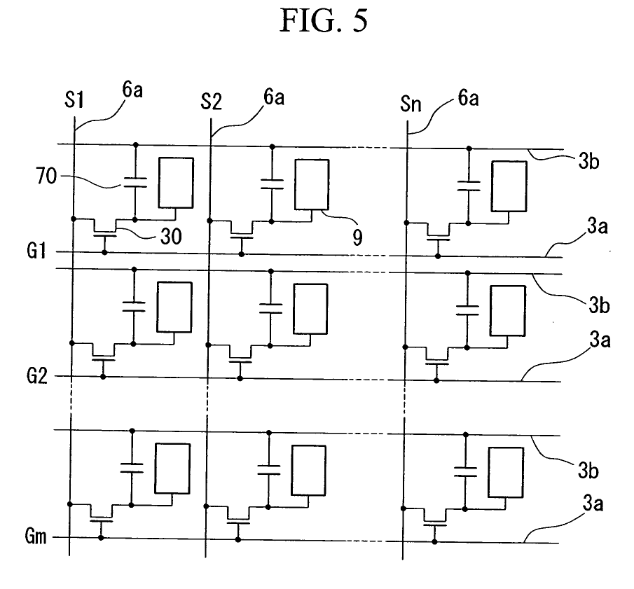

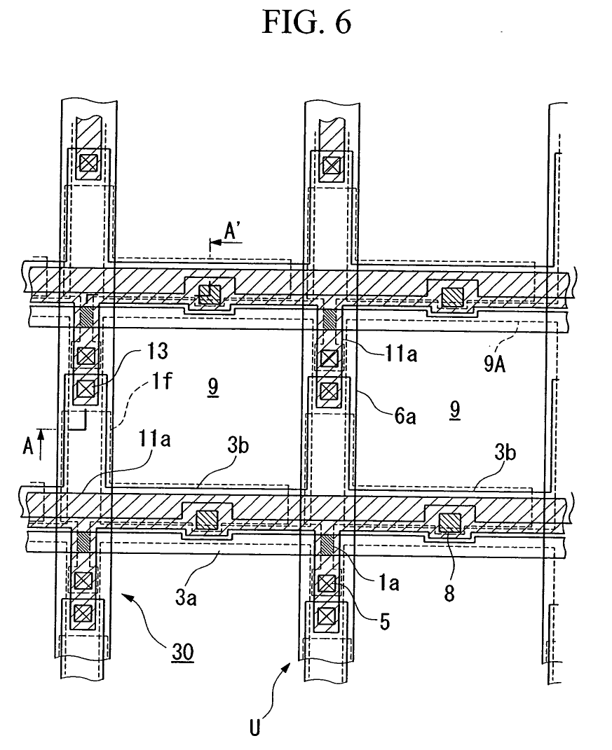

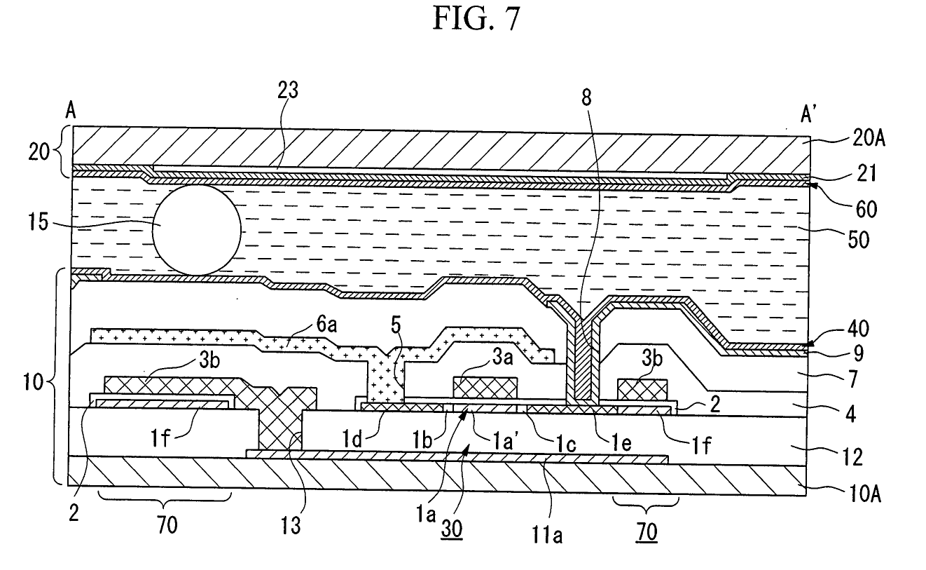

The liquid crystal display device shown in FIGS. 5 to 7 as an example of an electro-optic device of this aspect is an active-matrix transmissive-type liquid crystal device, using TFTs (Thin Film Transistors) as switching elements. FIG. 5 is an equivalent circuit diagram of the switching elements, signal lines and similar in a plurality of pixels arranged in a matrix in the transmissive liquid crystal device of this aspect. FIG. 6 is a plane view of principal portions, showing the structure of a plurality of adjacent pixels on a TFT array substrate on which are formed data lines, scan lines, pixel electrodes, and similar. FIG. 7 is a cross-sectional view along line A-A′ in FIG. 6. In FIG. 7, the upper side in the drawing is the light incidence side, and the lower side is the visible side (the observer side). In each of the drawings, scales are changed for each layer and for each member in order that the different layers and different members can be of a size enabling recognition in the drawing.

In the liquid crystal display device of this aspect, as shown in FIG. 5, pixel electrodes 9, and TFT elements 30, which are switching elements to control the passage of current to pixel electrodes 9, are formed in the plurality of pixels arranged in a matrix, and data lines 6a to which are supplied image signals are electrically connected to the sources of the TFT elements 30. Image signals S1, S2, . . . , Sn input to data lines 6a are either supplied in line sequence in this order, or else are supplied in groups to a plurality of adjacent data lines 6a.

The scan lines 3a are electrically connected to the gates of the TFT elements 30, and scan signals G1, G2, . . . , Gm are applied in line sequence in pulse form, at prescribed timing, to a plurality of scan lines 3a. Pixel electrodes 9 are electrically connected to the drains of TFT elements 30, and by turning on the TFT element 30 which is a switching element for a fixed period, image signals S1, S2 . . . , Sn from data lines 6a are inputted at prescribed timing.

Image signals S1, S2, . . . , Sn at a prescribed level, written to the liquid crystals via the pixel electrodes 9, are held for a fixed period with a common electrode, described below. Liquid crystals can modulate light and effect grayscale display by changing the alignment and order of molecule groups according to the applied voltage level. Here, in order to prevent leakage of image signals being held, a storage capacitance 70 is added in parallel to the liquid crystal capacitance formed between pixel electrodes 9 and the common electrode.

Next, the plane-view construction of the principal portions of the liquid crystal display device of this aspect is explained. As shown in FIG. 6, a plurality of rectangular pixel electrodes (the outlines of which are indicated by the broken lines 9A), comprising indium tin oxide (hereafter “ITO”) or some other transparent conductive material, are provided in a matrix, and data lines 6a, scan lines 3a, and capacitance lines 3b are provided along the vertical and horizontal borders of the pixel electrodes 9. In this aspect, the areas in which are formed each of the pixel electrodes 9, with data lines 6a, scan lines 3a, and capacitance lines 3b arranged so as to surround each pixel electrode 9, are pixels, in a configuration in which it is possible to effect display of each pixel arranged in a matrix. The areas formed in a vertical-horizontal lattice, in which are formed data lines 6a, scan lines 3a, and capacitance lines 3b surrounding each pixel electrode 9, are taken to be non-display areas in which images are not displayed.

The data lines 6a are electrically connected, via contact holes 5, to source areas described below comprised by the TFT elements 30 in the semiconductor layer 1a comprising for example a silicon film. Pixel electrodes 9 are electrically connected, via contact holes 8, to drain areas described below in the semiconductor layer 1a. Scan lines 3a are arranged to oppose channel areas described below (the areas with oblique lines running left-upward in FIG. 6) in the semiconductor layer 1a; the scan lines 3a function as gate electrodes in portions opposing channel areas.

Capacitance lines 3b have main line portions (that is, seen in plane view, first areas formed along scan lines 3a) which extend substantially linearly along scan lines 3a, and protruding portions (that is, seen in plane view, second areas, provided to extend along data lines 6a) which protrude from the locations of intersections with data lines 6a on the previous-stage side (upward in FIG. 6) along data lines 6a. In FIG. 6, a plurality of first shield films 11 are provided in the areas with oblique lines running right-upward.

Next, the cross-sectional structure of the liquid crystal display device of this aspect is explained, based on FIG. 7. FIG. 7 is a cross-sectional view along line A-A′ in the above-described FIG. 6, showing the configuration of an area in which is formed a TFT element 30. In the liquid crystal device of this aspect, the liquid crystal layer 50 is enclosed between the TFT array substrate 10 and an opposing substrate 20 positioned in opposition thereto.

The liquid crystal layer 50 comprises for example liquid crystals of one type, or a mixture of a plurality of types of nematic liquid crystals, in a prescribed alignment state between the pair of alignment films 40 and 60. The TFT array substrate 10 comprises the substrate proper 10A, of quartz or some other transparent material; TFT elements 30, formed on the surface of the side of the liquid crystal layer 50; pixel electrodes 9; and the alignment film 40. The opposing substrate 20 comprises the substrate proper 20A, of glass, quartz, or some other transparent material; a common electrode 21, formed on the surface of the side of the liquid crystal layer 50; and the alignment film 60. The substrates 10, 20 are held at a prescribed interval with spacers 15 intervening.

In the TFT array substrate 10, pixel electrodes 9 are provided on the surface of the substrate proper 10A on the side of the liquid crystal layer 50; and TFT elements 30 for pixel switching, which control switching of each of the pixel electrodes 9, are provided at positions adjacent to each of the pixel electrodes 9. The TFT elements 30 for pixel switching have a LDD (Lightly Doped Drain) structure, and comprise a scan line 3a; channel area 1a′ in the semiconductor layer 1a in which a channel is formed by the electric field from the scan line 3a; gate insulating film 2 which insulates the semiconductor layer 1a from the scan line 3a; data line 6a; low-concentration source area 1b and low-concentration drain area 1c in the semiconductor layer 1a; and high-concentration source area 1d and high-concentration drain area 1e in the semiconductor layer 1a.

On the substrate proper 10A, including the scan line 3a and gate insulating film 2, is formed a second interlamellar insulating film 4, in which are opened a contact hole 5 to the high-concentration source area 1d and a contact hole 8 to the high-concentration drain area 1e. That is, the data line 6a is electrically connected to the high-concentration source area 1d via a contact hole 5 which penetrates the second interlamellar insulating film 4.

On the data line 6a and second interlamellar insulating film 4 is formed a third interlamellar insulating film 7, in which is opened a contact hole 8 to the high-concentration drain area 1e. That is, the high-concentration drain area 1e is electrically connected to the pixel electrode 9 via the contact hole 8 which penetrates the second interlamellar insulating film 4 and the third interlamellar insulating film 7.

On the surface, on the side of the liquid crystal layer 50, of the substrate proper 10A of the TFT array substrate 10, in areas in which TFT elements 30 for electrode switching are formed, is provided a first shield film 11a to prevent the incidence onto, at least, the channel area 1a′, low-concentration source area 1b and low-concentration drain area 1c of the semiconductor layer 1a, of return light which has passed through the TFT array substrate 10 and been reflected at the lower surface in the figure of the TFT array substrate 10 (the interface between the TFT array substrate 10 and air).

Furthermore, a first interlamellar insulating film 12 is formed between the first shield film 11a and the TFT elements 30 for pixel switching, to electrically insulate the semiconductor layer 1a comprising the TFT elements 30 for pixel switching from the first shield film 11a. As shown in FIG. 6, in addition to providing the first shield film 11a on the TFT array substrate 10, the first shield film 11a is configured so as to be electrically connected to the previous-stage or following-stage capacitance line 3b via a contact hole 13.

Furthermore, an alignment film 40, which controls the alignment of liquid crystal molecules within the liquid crystal layer 50 during voltage application, is formed on the uppermost surface of the TFT array substrate 10 on the side of the liquid crystal layer 50, that is, on the pixel electrodes 9 and third interlamellar insulating film 7. Hence in an area comprising such TFT elements 30, a plurality of steps or irregularities are formed on the uppermost surface of the TFT array substrate 10 on the side of the liquid crystal layer 50, that is, on a surface enclosing the liquid crystal layer 50.

On the opposing substrate 20, on the other hand, a second shield film 23, to prevent intrusion of incident light in the channel areas 1a′, low-concentration source areas 1b, and low-concentration drain areas 1c of the semiconductor layer 1a of TFT elements 30 for pixel switching, is provided on the surface of the substrate proper 20A on the side of the liquid crystal layer 50, in areas opposing the areas of formation of data lines 6a, scan lines 3a, and TFT elements 30 for pixel switching, that is, in areas other than the aperture areas of each of the pixel portions. Further, a common electrode 21 of ITO or similar is formed over substantially the entire surface of the substrate proper 20A on which the second shield film 23 is formed, on the side of the liquid crystal layer 50; and on the side of the liquid crystal layer 50 is formed an alignment film 60 which controls the alignment of liquid crystal molecules within the liquid crystal layer 50 during voltage application.

Method of Manufacture of Liquid Crystal Display Device

Next, the method of manufacture of a liquid crystal display device, comprising the liquid crystal device described in the above aspect, is explained, referring to the drawings.

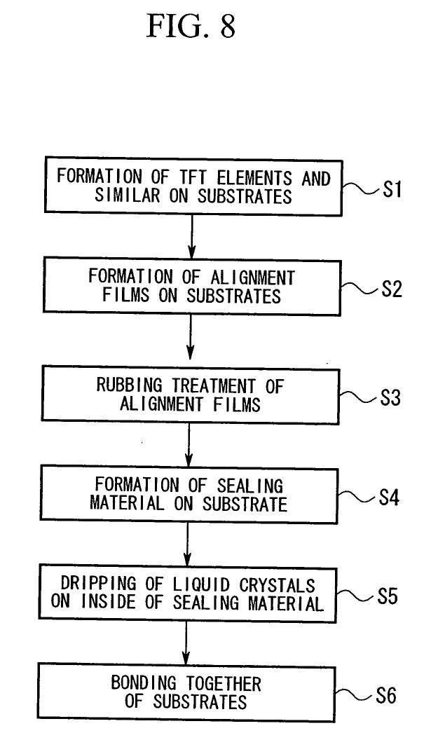

FIG. 8 is a diagram explaining the flow of processes in the method of manufacture of the liquid crystal device of the aspect. In this manufacturing method, alignment films are formed on a pair of substrates, the alignment films are subjected to rubbing treatment, and after forming sealing material into a frame on one of the substrates, liquid crystals are dripped into the sealing material frame, and the other substrate is set in place. Below, the flow of processes is explained in detail.

First, as indicated by step S1 in FIG. 8, the shield film 11a, first interlamellar insulating film 12, semiconductor layer 1a, channel areas 1a′, low-concentration source areas 1b, low-concentration drain areas 1c, high-concentration source areas 1d, high-concentration drain areas 1e, storage capacitance electrodes 1f, scan lines 3a, capacitance lines 3b, second interlamellar insulating film 4, data line 6a, third interlamellar insulating film 7, contact holes 8, and pixel electrodes 9 are formed, in order to configure TFT elements 30 on the lower-side substrate proper 10A, formed from glass or similar.

Next, as indicated by step S2 in FIG. 8, the alignment film liquid is applied to the substrate proper 10A to form the alignment film 40.

Then, as indicated by step S3 in FIG. 8, the alignment film 40 is subjected to rubbing treatment in a prescribed direction, tot create the TFT array substrate 10. A shield film 23, common electrode 21, and alignment film 60 are also formed on the upper-side substrate proper 20A, and the alignment film 60 is subjected to rubbing treatment in a prescribed direction to create the opposing substrate 20.

Next, in step S4 of FIG. 8, a frame of sealing material is formed on the opposing substrate 20 or on the TFT array substrate 10. The sealing material, for which an ultraviolet ray-hardening resin or similar is used, is formed into a frame shape (a closed frame shape not having an aperture for liquid crystal injection) by a printing method or similar. At this time, spacers 15 are dispersed within the sealing material in order to maintain a prescribed interval between substrates.

Next, in step S5 in FIG. 8, a prescribed amount of liquid crystal material, in keeping with the cell thickness of the liquid crystal device, is dripped onto the TFT array substrate 10 onto which the sealing material [frame] has been formed. Then, in step S6 of FIG. 8, the TFT array substrate 10 onto which the liquid crystals have been dripped, and the other, opposing substrate 20 are bonded together so as to enclose the liquid crystals. Further, a phase difference plate, polarization plate and other optical films, not shown, are laminated onto the outer surfaces of the TFT array substrate 10 and opposing substrate 20, to manufacture a liquid crystal device, which is a display device comprising the cell structure shown in FIG. 7.

In the liquid crystal device, the alignment films 40 and 60 are fabricated by ejection of droplets of a liquid comprising the alignment film formation material, using the above-described droplet ejection device 300, and drying. In addition to the alignment films 40 and 60, the above-described droplet ejection device 300 can be used to form the liquid crystal layer 50 and overcoat films, color filters and similar, not shown.

Hence by using the droplet ejection device 300 of this aspect, declines in quality due to instability of ink ejection and changes with time, as well as drops in production efficiency due to reduced yields, can be prevented.

Further, in the aspect the alignment film or similar is formed using a droplet ejection method, so that compared with flexography methods the amount of material used and the amount of waste liquid can be greatly reduced, there is a substantial advantage in conservation of energy, and larger substrates can easily be accommodated, so that films of still higher quality can be fabricated.

A droplet ejection device 300 of this invention may, in addition to use in the above-described manufacture of liquid crystal panels, can also be used in the manufacture of, for example, organic EL devices, which use as pixels an organic functional layer which emits light when a current is passed, and in the manufacture of other electro-optical devices. When applying this invention to organic EL devices, the organic functional layer is formed using a droplet ejection device of this invention.

Further, in addition to liquid crystal panels and organic EL devices, application to metal wiring, organic thin film transistors, resistors, microlens arrays, and to bio-engineering is also possible.

Electronic Equipment

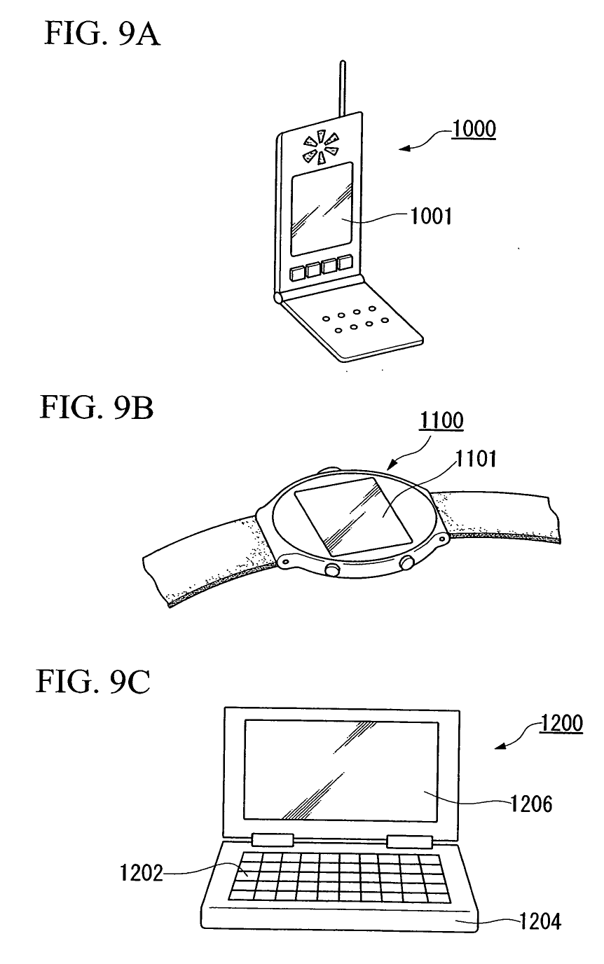

FIGS. 9A to 9C show aspects of electronic equipment of the invention.

The electronic equipment of these examples comprises the liquid crystal device as display means.

FIG. 9A is a perspective view showing an example of a portable telephone. In FIG. 9A, the symbol 1000 denotes the portable telephone unit, and the symbol 1001 denotes a display portion which uses the liquid crystal device.

FIG. 9B is a perspective view showing an example of a wristwatch-type electronic device. In FIG. 9B, the symbol 1100 denotes the watch itself, and the symbol 1101 denotes a display portion using the liquid crystal device.

FIG. 9C is a perspective view showing an example of a word processor, personal computer, or other portable information processing device. In FIG. 9C, the symbol 1200 denotes the information processing device, the symbol 1202 denotes a keyboard or other input portion, the symbol 1204 denotes the information processing device main unit, and the symbol 1206 denotes a display portion using the liquid crystal device.

Each of the examples of electronic equipment shown in FIGS. 9A to 9C comprises the liquid crystal device as display means, so that high-quality electronic equipment can be obtained.

In electronic equipment of this aspect, high-quality electronic equipment can be obtained without instability in ink ejection or changes with time; and electronic equipment can be obtained which affords cost reductions without drops in production efficiency.

In the above, preferred embodiments of the invention have been explained; but this invention is not limited to these embodiments. Various additions, omissions, substitutions, and other modifications can be made to the configuration, without deviating from the gist of the invention. This invention is not limited to the above explanations, but is limited only by the scope of the attached claims.

This invention enables prevention of a decline in quality due to unstable liquid ejection and changes with time as well as a decline in production efficiency due to reduced production yields. Further, this invention enables the supply of high-quality, low-cost electro-optic devices and electronic equipment.

What is claimed is:

1. A liquid package comprising:
a bag in which is sealed a liquid that is degasified at a pressure higher than a saturated vapor pressure of a solvent in the liquid.

2. The liquid package according to claim 1, wherein the bag has flexibility.

3. A liquid package comprising:
a bag in which is sealed a liquid that has plural solvents and is degasified at a pressure higher than a saturated vapor pressure of one of the solvents with a highest saturated vapor pressure.

4. The liquid package according to claim 3, wherein the bag has flexibility.

5. A liquid package comprising:
a bag in which is sealed a liquid that has plural solvents and is degasified at a pressure higher than a saturated vapor pressure of one of the solvents for which the composition ratio is highest.

6. The liquid package according to claim 5, wherein the bag has flexibility.

7. A liquid droplet ejection device comprising:
an ejection head which ejects droplets; and
a supply unit which supplies a liquid to the ejection head and has a liquid package in which is sealed the liquid that is degasified at a pressure higher than a saturated vapor pressure of a solvent in the liquid.

8. The liquid droplet ejection device according to claim 7, wherein the liquid package has a flexible bag holding the liquid.

9. The liquid droplet ejection device according to claim 8, wherein the liquid package has a flat shape and a liquid supply port and is placed substantially horizontally, and the liquid supply port is directed in a substantially horizontal direction.

10. The liquid droplet ejection device according to claim 7, further comprising an elevating device which raises and lowers the liquid package.

11. A liquid droplet ejection device comprising:
an ejection head which ejects droplets; and
a supply unit which supplies a liquid to the ejection head and has a liquid package in which is sealed the liquid that has plural solvents and is degasified at a pressure higher than a saturated vapor pressure of one of the solvents with a highest saturated vapor pressure.

12. A liquid droplet ejection device comprising:
an ejection head which ejects droplets; and
a supply unit which supplies a liquid to the ejection head and has a liquid package in which is sealed the liquid that has plural solvents and is degasified at a pressure higher than a saturated vapor pressure of one of the solvents for which the composition ratio is highest.

13. An electro-optic device, comprising a substrate manufactured by using the liquid droplet ejection device according to claim 7.

14. An electronic equipment, comprising the electro-optic device according to claim 13.
